(19) United States
(12) Patent Application Publication
(10) Pub. No.: US 2026/0078457 A1
(43) Pub. Date: Mar. 19, 2026

(54) FLUIDIZED BED IRONMAKING PROCESS AND SYSTEM

(71) Applicant: Charm Industrial, Inc., San Francisco, CA (US)

(72) Inventors: Brian Jamieson, Brighton, CO (US); Joseph Polin, San Francisco, CA (US); Edward Young, Albany, CA (US)

(21) Appl. No.: 19/323,731

(22) Filed: Sep. 9, 2025

Related U.S. Application Data
(60) Provisional application No. 63/695,555, filed on Sep. 17, 2024.

(51) Int. Cl. C21B 13/00; B01D 53/047; C21B 13/14

(52) U.S. Cl. CPC C21B 13/0033; B01D 53/047; C21B 13/0073; C21B 13/14; B01D 2257/504; B01D 2258/0283; C21B 2100/282

(57) ABSTRACT

In various examples, the subject matter of this disclosure relates to a method and a system for producing metallic iron. An example method includes: obtaining bio-oil; obtaining iron ore fines; providing the bio-oil to a gasifier to produce syngas from the bio-oil, the syngas including tar and/or particulate; and providing the syngas and the iron ore fines to a fluidized bed reactor where iron oxide in the iron ore fines is at least partially reduced using the syngas.

### CROSS-REFERENCE TO RELATED APPLICATIONS

This application claims the benefit of U.S. Provisional Patent Application No. 63/695,555, filed on Sep. 17, 2024, the entire contents of which are incorporated by reference herein.

### BACKGROUND

Synthesis gas (syngas) is used by a variety of industrial processes for the production of various materials, such as methanol production for plastics and fabrics, kerosene production for airplanes, iron ore reduction for, among other applications, steel production, and ammonia production for fertilizer. Typically, a fossil fuel feedstock like coal or natural gas is used to produce syngas. Such use of fossil fuels can significantly increase global carbon dioxide (CO₂) emissions.

Iron ore is traditionally reduced in blast furnaces or direct reduction furnaces where particles of the iron ore, provided as lumps and/or pellets, are contacted with syngas. Reducing agents in the syngas, such as carbon monoxide (CO) and hydrogen (H₂), strip oxygen atoms off iron oxide in the iron ore to produce metallic iron.

There is a need for improved systems and methods for reducing iron oxide to produce metallic iron.

### SUMMARY

In various examples, the subject matter of this disclosure relates to systems and methods for producing metallic iron from iron oxide. Iron ore fines and syngas (e.g., produced from bio-oil) can be provided to a fluidized bed reactor where iron oxide in the iron ore fines reacts with reducing agents (e.g., CO and H₂) in the syngas. Additional fluidized bed reactors (e.g., arranged in series) can be used to further reduce the iron oxide and produce metallic iron. Carbon dioxide can be captured from a gas stream exiting a fluidized bed reactor (e.g., spent or partially spent syngas) to reduce carbon emissions and/or achieve systems and methods that are carbon negative.

In one aspect, the subject matter of this disclosure relates to a system for producing metallic iron. The system includes: a source of bio-oil; a source of iron ore fines and/or iron ore concentrate; a gasifier for producing syngas from the bio-oil, the syngas including tar and/or particulate; and a fluidized bed reactor in fluid communication with the gasifier and configured to: receive the syngas from the gasifier; fluidize the iron ore fines; and at least partially reduce iron oxide in the iron ore fines using the syngas.

In another aspect, the subject matter of this disclosure relates to a method of producing metallic iron. The method includes: obtaining bio-oil; obtaining iron ore fines and/or iron ore concentrate; providing the bio-oil to a gasifier to produce syngas from the bio-oil, the syngas including tar and/or particulate; and providing the syngas and the iron ore fines to a fluidized bed reactor where iron oxide in the iron ore fines is at least partially reduced using the syngas.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings.

FIG. 1 is a schematic diagram of a system for producing syngas from bio-oil and using the syngas to reduce iron oxide in iron ore fines, in accordance with some embodiments.

FIG. 2 is a schematic representation of a fluidized bed reactor for reducing iron oxide using syngas produced from bio-oil, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

A description of example embodiments follows. It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

Iron and steelmaking account for 8% of global CO₂ emissions. The largest contributor to these emissions is blast furnaces, which produce roughly 80-90% of global primary iron. Many blast furnaces are fed with lower grade feeds that must be sintered, which reduces their applicability in alternative processes like direct reduced ironmaking with pellets. As described herein, fluidized bed ironmaking can accommodate many of these lower grade feed materials, and doing so with bio-oil gasification can substantially reduce net CO₂ emissions, compared to existing approaches. Further, in some examples, the availability of high grade iron ore sufficient for direct application in electric arc furnaces (EAFs) is limited, and there is a need for ironmaking systems and methods, such as those described herein, that can utilize lower grade iron ore.

The direct use of syngas produced from bio-oil for ironmaking reduction as described herein has several advantages. For example, the systems and methods described herein offer a pathway to carbon negative ironmaking through capture and sequestration of biogenic CO₂. Further, while previous approaches may require syngas to be cleaned after gasification and prior to ironmaking, the systems and methods described herein can use a crude, uncleaned syngas for ironmaking. For example, iron ore fines in a fluidized bed can catalyze chemical reactions that convert tar and/or particulate in the crude syngas into reducing gases (e.g., CO and H₂).

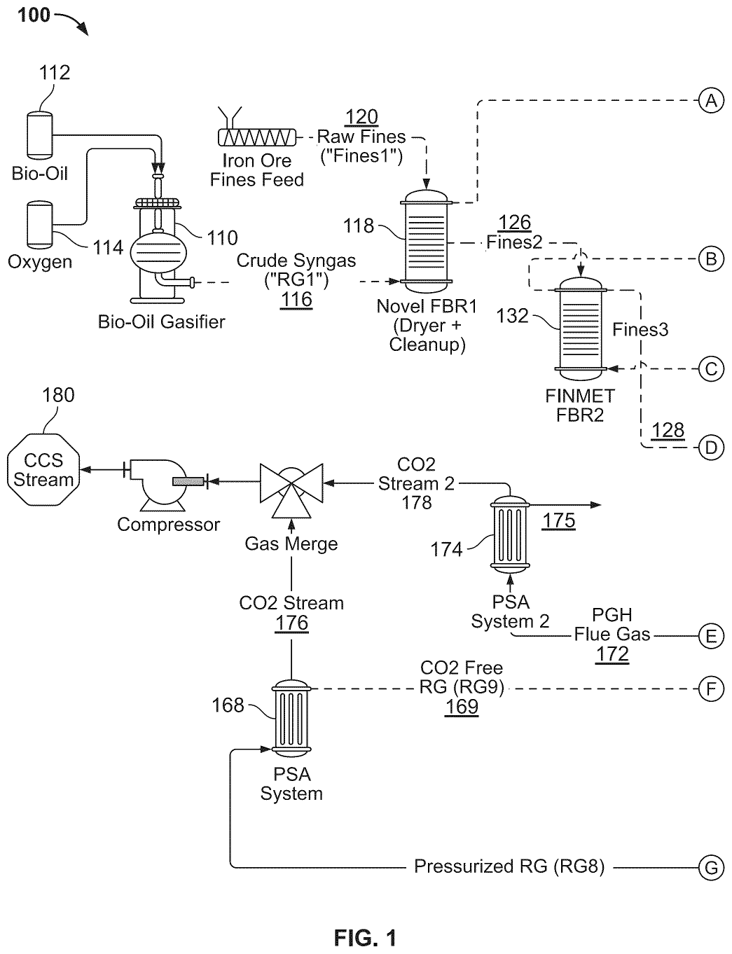

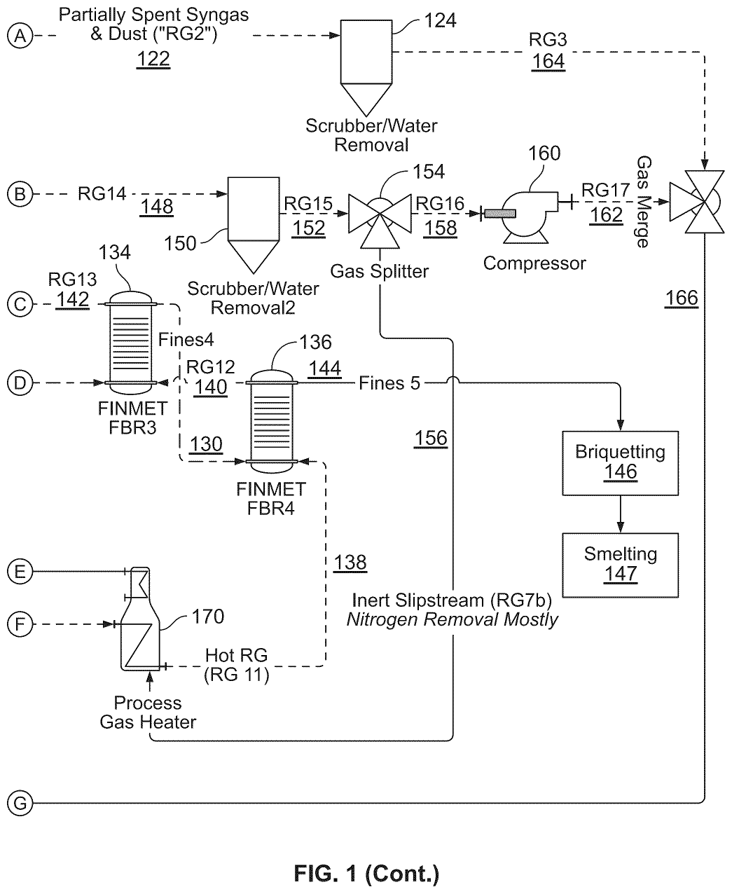

FIG. 1 is a schematic diagram of a system 100 for reducing iron ore to metallic iron, in accordance with certain examples. The system 100 includes a bio-oil gasifier 110 that receives bio-oil 112 (e.g., derived from biomass in a pyrolysis process) and oxygen 114 (e.g., pure oxygen) as inputs and provides a crude syngas 116 as output. The bio-oil gasifier 110 can be or include, for example, a bio-oil reformer, an autothermal reformer, or an autothermal entrained flow gasifier. The gasifier 110 can operate at a temperature from about 1000° C. to about 1600° C., from about 1200° C. to about 1400° C., or about 1300° C. A pressure in the gasifier 110 can be from about 1 bar to about 34 bar, from about 20 bar to about 34 bar, or about 27 bar (absolute). The bio-oil 112 and/or the oxygen 114 can be pre-heated before entering the gasifier 110. Additionally or alternatively, the bio-oil 112 in the gasifier 110 can be atomized. Systems and methods for producing syngas in a bio-oil gasifier are described in U.S. Patent Application Publication No. 2025/0091863, titled “Systems and Methods for Producing Syngas from Bio-Oil,” the entire disclosure of which is incorporated by reference.

The syngas 116 produced by the gasifier 110 can include carbon monoxide (CO), carbon dioxide (CO₂), hydrogen (H₂), water vapor (H₂O), methane (CH₄), nitrogen (N₂), unconverted tar (e.g., higher-order hydrocarbon compounds), particulate (e.g., carbon and/or ash), or any combination thereof. Smaller trace gas species may also be present. The composition of the syngas 116 can vary according to process conditions in the gasifier 110 and/or the bio-oil feed composition. For example, Table 1 presents exemplary syngas compositions corresponding to a heavy ends bio-oil feed and a light ends bio-oil feed. As shown, syngas produced with the heavy-ends bio-oil feed may contain higher concentrations of CO and H₂, compared to syngas produced with the light-ends bio-oil feed. Thus, in some cases, syngas produced with heavy ends bio-oil feed can be a more favorable reducing gas than syngas produced with light ends bio-oil feed (e.g., due to higher concentrations of CO and H₂). In general, syngas composition is a function of bio-oil composition and/or reformer performance. The ranges in Table 1 are exemplary of certain bio-oils that have been tested. Syngas compositions that fall outside the ranges in Table 1 are possible.

TABLE 1
Example syngas compositions.

| Heavy Ends | | | Light Ends | | |
|---|---|---|---|---|---|
| mol % | Minimum | Maximum | mol % | Minimum | Maximum |
| Particulate | 0 | 4.8 | Particulate | 0 | 4 |
| Tars | 0 | 1 | Tars | 0 | 1 |
| H₂O | 0.5 | 25 | H₂O | 10 | 40 |
| CO | 40 | 60 | CO | 20 | 45 |
| CO₂ | 5 | 15 | CO₂ | 10 | 30 |
| CH₄ | 0.5 | 5 | CH₄ | 0.5 | 15 |
| H₂ | 22 | 35 | H₂ | 10 | 20 |
| O₂ | 0 | 3 | O₂ | 0 | 3 |
| N₂ | 0 | 5 | N₂ | 0 | 5 |

Still referring to FIG. 1, in various examples, the hot syngas 116 from the gasifier 110 (e.g., at about 1300° C. and/or 27 bar) is piped directly into a fluidized bed reactor 118 containing unreduced iron oxide fines 120. For example, the reactor 118 can be in fluid communication with the gasifier 110, such that the system 100 can including piping that directs the syngas 116 from the gasifier 110 to the reactor 118. The iron oxide fines 120 can have particle sizes (e.g., maximum or average diameters) from about 50 μm to about 150 μm, from about 150 μm to about 1 mm, from about 1 mm to about 3 mm, or from about 3 mm to about 6 mm. The fines 120 can enter the reactor at a temperature of about 25° C. and/or can be heated by the syngas 116 to a temperature from about 400° C. to about 1000° C. A temperature in the reactor 118 can be, for example, from about 500° C. to about 1000° C., or about 750° C. A pressure in the reactor 118 can be, for example, from about 1 bar to about 40 bars, from about 10 bars to about 30 bars, or about 22 bar (absolute). The syngas 116 can dry the iron ore fines by evaporating water on or in the fines. The evaporated water can be carried away by a gas stream 122 that exits the reactor 118.

In various examples, the syngas 116 can at least partially reduce the iron ore fines 120. For example, reducing gases in the syngas 116 (e.g., CO and/or H₂) can initiate a limited amount of pre-reduction of the iron ore fines 120 in the reactor 118. The pre-reduction occurring in the reactor 118 can amount to about 10%, about 20%, about 30%, about 40%, about 50%, about 60%, about 70%, or greater metallization of the iron ore fines 120 (e.g., with 100% being complete metallization). In some cases, producing iron from iron ore can include the following transition(s): Fe₂O₃ (“hematite”)→Fe₃O₄ (“magnetite”), Fe₃O₄→FeO (“wustite”)→Fe (metallic iron). Overall, this route can be simplified as Fe₂O₃→Fe. For example, the reducing agent (e.g., CO and/or H₂) can remove oxygen from Fe₂O₃ to produce Fe plus CO₂ and/or H₂O.

In certain examples, moisture in the reactor 118 (e.g., produced by drying the iron ore fines) can interact with tar and/or particulate in the syngas 116 to yield increased amounts of reducing gases. These reactions can include, for example:

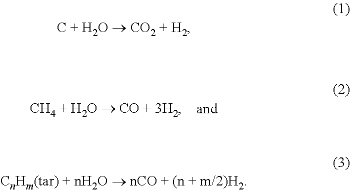

The reactions associated with the tar and particulate conversion can be catalyzed by the iron ore fines 120. Additionally or alternatively, the iron ore fines 120 can remove heat from the syngas 116 as a quenching process, so that the gas stream 122 exiting the reactor can be handled or treated more effectively in downstream cleanup processes. The reactor 118 can serve as a preheating and/or drying step for the iron ore fines 120.

In various implementations, the gas stream 122 exiting the reactor 118 can have a lower concentration of reducing gases (e.g., CO and/or H₂), compared to the syngas 116, and can be referred to as a “partially spent syngas.” The gas stream 122 can include dust (e.g., iron ore dust) and/or particulate (e.g., carbon particulate) and/or can have a temperature of about 500° C. and/or a pressure of about 22 bar (absolute). The temperature and pressure values can vary depending on the operating conditions of the reactor 118. A scrubber and/or condenser 124 can be used to remove dust and water from the gas stream 122.

The partially reduced fines from the reactor 118 can be provided to one or more additional fluidized bed reactors. In the depicted embodiment, for example, the fines are fed in a series of streams 126, 128, and 130 through fluidized bed reactors 132, 134, and 136. A hot reducing gas (e.g., containing CO and/or H₂) can be fed through the reactors 132, 134, and 136 in an opposite direction in streams 138, 140, and 142. The reducing gas can further reduce the iron oxide in the reactors 132, 134, and 136 to produce fines 144 of metallic iron. A temperature in the reactors 132, 134, and/or 136 can be, for example, from about 500° C. to about 1000° C., or about 750° C. A pressure in the reactors 132, 134, and/or 136 can be, for example, from about 1 bar to about 40 bars, from about 10 bars to about 30 bars, or about 22 bar (absolute). While the depicted embodiment includes four fluidized bed reactors (reactors 118, 132, 134, and 136), other embodiments can include a different number of fluidized bed reactors (e.g., 1, 2, 3, 5, or more).

The metallic iron fines 144 from reactor 136 can be provided to a briquetting process 146 where the fines 144 can be compressed to form briquettes. The metallic fines 144 (e.g., in briquette form) can be provided to a smelting furnace 147 (e.g., an electric smelting furnace) where a gangue fraction (e.g., slag or non-ferrous components, such as SiO₂, Al₂O₃, CaO, and/or MgO) can be separated from an iron fraction, to produce an end product iron fraction having a higher concentration of metallic iron (e.g., about 90 wt % Fe or higher).

Still referring to FIG. 1, a stream 148 of spent reducing gas exiting reactor 132 can be provided to a scrubber and/or condenser 150 where fines, dust, and/or water are removed. A gas stream 152 exiting the scrubber and/or condenser 150 can be provide to a gas splitter 154, which can produce a slipstream of syngas 156 and a reducing gas stream 158 (e.g., containing CO and/or H₂). The reducing gas stream 158 can be compressed in a compressor 160 to produce gas stream 162. Gas stream 162 can be merged with a gas stream 164 exiting the scrubber and/or condenser 124 to produce a reducing gas stream 166. The reducing gas stream 166 can be provided to a pressure swing adsorption (PSA) device 168, an amine absorption device, a membrane separation device, and/or other suitable carbon capture device, which can remove carbon dioxide from the gas stream 166 and produce gas stream 169, containing less carbon dioxide than gas stream 166. A process gas heater 170 is used to heat the gas stream 169 (e.g., via a heat exchanger) and output the hot reducing gas stream 138, which is fed to the reactor 136. The process gas heater 170 can generate heat with an electric heater and/or by burning a fuel source (e.g., bio-oil or reducing gas).

In various examples, the process gas heater 170 receives the slipstream 156 from the scrubber and/or condenser 150 and outputs a flue gas stream 172, for example, containing components from the slipstream 156 and/or exhaust from a combustion reaction used to generate heat in the process gas heater 170. The flue gas stream 172 can be provided to a PSA device 174 (or other suitable carbon capture device), which can remove carbon dioxide from the flue gas stream 172. A gas stream 175 that remains after the carbon dioxide removal can be mostly water vapor and/or can be sent to atmosphere via a stack or similar exhaust management tool. A stream 176 of carbon dioxide from the PSA device 168 and a stream 178 of carbon dioxide from the PSA device 174 can be merged and/or compressed to form a carbon capture stream 180. Carbon dioxide in the carbon capture stream 180 can be sequestered (e.g., in an underground formation) and/or can be used in a variety of processes to form various products (e.g., methane or aviation fuel). Sequestering the carbon dioxide, which originates from carbon in bio-oil, can achieve carbon dioxide removal (CDR) because the sequestered carbon is not returned to the atmosphere.

In certain examples, the PSA devices 168 and 174 can perform a pressure swing adsorption process in which gases flow over a bed of selectively adsorbent materials at different pressures, to allow some gases like CO₂ to selectively adsorb to the adsorbent while other gases pass through. The PSA devices 168 and 174 can then be depressurized to release the adsorbed CO₂ which is sent to a pipeline for handling. The PSA device 168 and/or the PSA device 174 can be replaced or supplemented with other technologies for capturing CO₂, such as, for example, vacuum pressure swing adsorption (VPSA), amine-based carbon capture, or membrane based separation.

In some implementations, use of PSA devices 168 and 174 to remove CO₂ can help ensure there is a suitable reducing potential of the gas (e.g., in stream 138) recirculated back to the fluidized bed reactors 132, 134, and 136. Removal of CO₂ (e.g., by PSA devices 168 and 174), water (e.g., by condensers 124 and 150), and/or inert gases (e.g., nitrogen) can increase the concentration of reducing gases (e.g., CO and/or H₂) in the gas streams fed to the reactors 132, 134, and 136. Further, removal of CO₂ to produce the carbon capture stream 180 can make the system 100 carbon negative, given that the CO₂ originates from biogenic sources (e.g., biomass used to produce the bio-oil). Capturing the CO₂ and sequestering the carbon capture stream 180 can achieve a net carbon removal from the atmosphere.

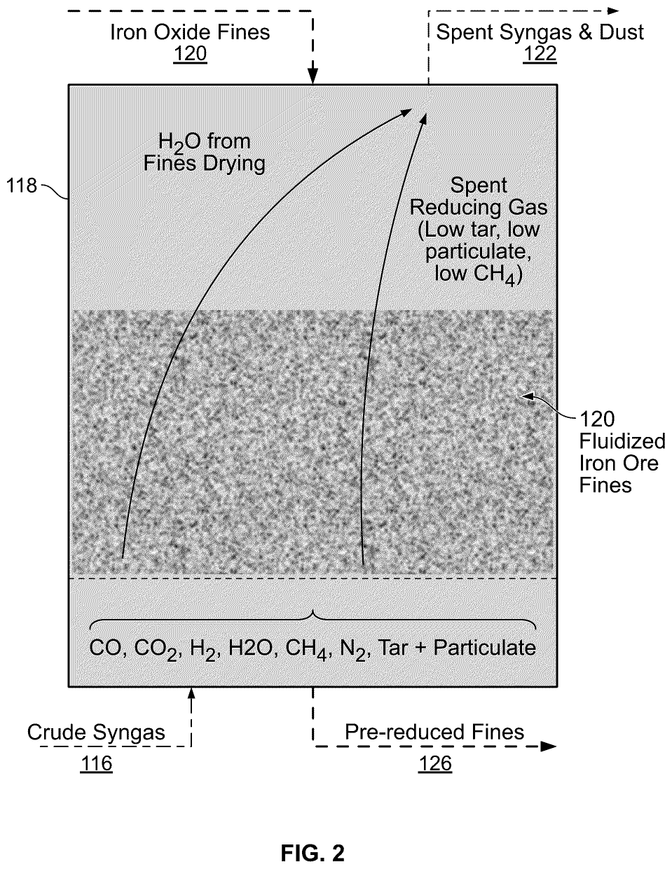

FIG. 2 is a schematic diagram of the fluidized bed reactor 118, in accordance with certain examples. The reactor 118 receives the syngas 116 and the iron oxide fines 120 as input, and produces the partially spent syngas 122 and a stream of pre-reduced fines 126 as output. The iron oxide fines 120 are fluidized in the reactor 118 where at least a portion of the iron oxide is reduced by reducing gases in the syngas 116. Water is evaporated from the fines 120 and exits the reactor 118 in the partially spent syngas 122.

Table 2 includes minimum, maximum, and typical temperature for various gas and fines streams shown in FIG. 1, in accordance with certain examples. Various embodiments include any parameter value (e.g., integer or decimal value) within the cited ranges, and each of these parameter values can represent an endpoint of a range. Express support and written description of these parameter values for each parameter are hereby represented.

TABLE 2
Exemplary temperatures for gas and fines streams in system 100.

| | Mini- | | Maxi- |
|---|---|---|---|
| Item | mum | Typical | mum |
| Temperature of Gas Stream 116 (° C.) | 800 | 1300 | 1500 |
| Temperature of Fines Stream 120 (° C.) | −25 | 25 | 200 |
| Temperature of Gas Stream 122 (° C.) | 350 | 500 | 950 |
| Temperature of Fines Stream 126 (° C.) | 250 | 450 | 650 |
| Temperature of Fines Stream 128 (° C.) | 475 | 575 | 675 |
| Temperature of Fines Stream 130 (° C.) | 550 | 650 | 750 |
| Temperature of Gas Stream 138 (° C.) | 750 | 850 | 1050 |
| Temperature of Gas Stream 140 (° C.) | 600 | 700 | 900 |
| Temperature of Gas Stream 142 (° C.) | 500 | 650 | 750 |
| Temperature of Fines Stream 144 (° C.) | 700 | 800 | 1000 |
| Temperature of Gas Stream 148 (° C.) | 450 | 550 | 650 |

Table 3 includes minimum, maximum, and typical pressures for various gas and fines streams shown in FIG. 1, in accordance with certain examples. Various embodiments include any parameter value (e.g., integer or decimal value) within the cited ranges, and each of these parameter values can represent an endpoint of a range. Express support and written description of these parameter values for each parameter are hereby represented. Specific pressures encountered or used can depend on the configuration and/or operating conditions of the gasifier (e.g., bio-oil gasifier 110) or other system components.

TABLE 3
Exemplary pressures for gas and fines streams in system 100.

| | Mini- | | Maxi- |
|---|---|---|---|
| Item | mum | Typical | mum |
| Absolute Pressure of Gas Stream 116 (bar) | 22 | 27 | 32 |
| Absolute Pressure of Fines Stream 120 (bar) | 0.5 | 1 | 2 |
| Absolute Pressure of Gas Stream 122 (bar) | 17 | 22 | 27 |
| Absolute Pressure of Fines Stream 126 (bar) | 7 | 12 | 17 |
| Absolute Pressure of Fines Stream 128 (bar) | 10 | 15 | 20 |
| Absolute Pressure of Fines Stream 130 (bar) | 13 | 18 | 23 |
| Absolute Pressure of Gas Stream 138 (bar) | 13 | 18 | 23 |
| Absolute Pressure of Gas Stream 140 (bar) | 10 | 15 | 20 |
| Absolute Pressure of Gas Stream 142 (bar) | 7 | 12 | 17 |
| Absolute Pressure of Fines Stream 144 (bar) | 13 | 18 | 23 |
| Absolute Pressure of Gas Stream 148 (bar) | 5 | 10 | 15 |

In various examples, the bio-oil used for the systems and methods described herein can be produced from biomass in a pyrolysis process. The biomass used to produce the bio-oil can include organic material derived from living organisms such as plants. Biomass can be or include, for example, harvested plant materials, agricultural waste (e.g., corn stover), forestry residue (e.g., branches, leaves, etc.), woody biomass (e.g., trees, shrubs, bushes, etc.), non-woody biomass (e.g., sugar cane, cereal straw, seaweed, algae, cotton, grass, kelp, soil, etc.), and/or processed waste (e.g., cereal husks and cobs, bagasse, nut shells, plant oil cake, sawmill waste, food waste, etc.). Biomass can include fat, oil, lignin, starch, cellulose, hemicellulose, or any combination thereof. In some examples, the bio-oil can be or include biocrude (e.g., derived from biomass in a hydrothermal liquefaction process). Additionally or alternatively, in certain cases, the bio-oil can be replaced in whole or in part by biochar, hydrochar, glycerol, biodiesel, ethanol, other alcohols, used cooking oils, vegetable oil, plant-based oils, solutions containing microbes or algae, biocrude, biocrude byproducts, other bio-based liquid or material, or any combination thereof.

In certain implementations, the iron ore fines or particles used for the systems and methods described herein (e.g., fed to reactor 118) can be or include iron ore powders, iron ore concentrate, iron oxide bearing feedstocks (e.g., mine tailings and/or other traditional wastes), iron ore fines, other iron ore particles, or any combination thereof. The iron oxide can be or include hematite, magnetite, wustite, or any combination thereof. In some instances, the use of iron ore fines or particles, as described herein, can make it easier for gases (e.g., CO and CO₂) to enter and exit interior portions of the iron ore. Compared to larger iron ore pellets, for example, the gases do not need to migrate or travel as far to reach iron oxide in interior portions of the particles. This can significantly increase reaction rates and reduce reaction times.

### ADDITIONAL CONSIDERATIONS

The construction and arrangement of the elements of the apparatus as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes, and omissions may be made in the design, operating conditions, and arrangement of the exemplary embodiments without departing from the spirit of the present subject matter.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

It should be also understood that as used in the description herein the meaning of “a,” “an,” and “the” includes plural reference unless the context clearly dictates otherwise. Also, as used in the description herein, the meaning of “in” includes “in” and “on” unless the context clearly dictates otherwise.

Each numerical value presented herein is contemplated to represent a minimum value or a maximum value in a range for a corresponding parameter. Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

Although the concepts and principles of operation for the systems in FIGS. 1 and 2 have been described with limited number of components for simplicity, these systems may include additional electrical and/or mechanical components necessary for their operation. Such components may include, but are not limited to, pipes, pipe connectors, pressure regulators, different types of valves, computers, electronic controllers, transformers, power supplies, electrical control panels, etc. These additional components are within the spirit and the scope of this disclosure.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

What is claimed is:

1. A system for producing metallic iron, the system comprising:
a source of bio-oil;
a source of iron ore fines;
a gasifier for producing syngas from the bio-oil, the syngas comprising tar and particulate; and
a fluidized bed reactor in fluid communication with the gasifier and configured to:
receive the syngas from the gasifier;
fluidize the iron ore fines; and
at least partially reduce iron oxide in the iron ore fines using the syngas.

2. The system of claim 1, wherein the iron ore fines have a particle size from about 50 μm to about 6 mm.

3. The system of claim 1, wherein the gasifier comprises a bio-oil reformer, an autothermal reformer, or an autothermal entrained flow gasifier.

4. The system of claim 1, wherein the fluid communication comprises piping that directs the syngas from the gasifier to the fluidized bed reactor.

5. The system of claim 1, wherein the syngas enters the fluidized bed reactor at a temperature from about 1100° C. to about 1400° C.

6. The system of claim 1, wherein the fluidized bed reactor converts at least a portion of the tar and particulate into reducing gas comprising at least one of carbon monoxide or hydrogen.

7. The system of claim 6, wherein iron or iron oxide in the iron ore fines catalyzes reactions that produce the reducing gas in the fluidized bed reactor.

8. The system of claim 1, further comprising at least one additional fluidized bed reactor configured to further reduce the iron oxide in the iron ore fines.

9. The system of claim 1, further comprising:
a carbon capture device configured to (i) receive a partially spent syngas produced by the fluidized bed reactor and (ii) remove carbon dioxide from the partially spent syngas to produce a reducing gas stream; and
a heater that preheats the reducing gas stream to produce a preheated reducing gas stream.

10. The system of claim 9, further comprising an additional fluidized bed reactor configured to receive the preheated reducing gas stream.

11. A method of producing metallic iron, the method comprising:
obtaining bio-oil;
obtaining iron ore fines;
providing the bio-oil to a gasifier to produce syngas from the bio-oil, the syngas comprising tar and particulate; and
providing the syngas and the iron ore fines to a fluidized bed reactor where iron oxide in the iron ore fines is at least partially reduced using the syngas.

12. The method of claim 1, wherein the iron ore fines have a particle size from about 50 μm to about 6 mm.

13. The method of claim 1, wherein the gasifier comprises a bio-oil reformer, an autothermal reformer, or an autothermal entrained flow gasifier.

14. The method of claim 1, wherein the syngas enters the fluidized bed reactor at a temperature from about 1100° C. to about 1400° C.

15. The method of claim 1, wherein the fluidized bed reactor converts at least a portion of the tar and particulate into reducing gas comprising at least one of carbon monoxide or hydrogen.

16. The method of claim 15, wherein iron or iron oxide in the iron ore fines catalyzes reactions that produce the reducing gas in the fluidized bed reactor.

17. The method of claim 1, further comprising providing the iron ore fines from the fluidized bed reactor to at least one additional fluidized bed reactor, wherein the at least one additional fluidized bed reactor further reduces iron oxide in the iron ore fines.

18. The method of claim 1, further comprising:
providing a partially spent syngas produced by the fluidized bed reactor to a carbon capture device;
using the carbon capture device to (i) remove carbon dioxide from the partially spent syngas and (ii) produce a reducing gas stream; and
heating the reducing gas stream in a heater to produce a preheated reducing gas stream.

19. The method of claim 18, further comprising providing the preheated reducing gas stream to an additional fluidized bed reactor.

20. The method of claim 18, further comprising providing the removed carbon dioxide for sequestration.
